(19) United States
(12) Patent Application Publication
(10) Pub. No.: US 2005/0237623 A1
(43) Pub. Date: Oct. 27, 2005

(54) Optical unit for an illumination system of a microlithographic projection exposure apparatus

(76) Inventors: Damian Fiolka, Oberkochen (DE); Manfred Maul, Aalen (DE)

Correspondence Address: YOUNG & BASILE, P.C., 3001 WEST BIG BEAVER ROAD, SUITE 624, TROY, MI, 48084, US

(21) Appl. No.: 11/063,310

(22) Filed: Feb. 22, 2005

Related U.S. Application Data
(60) Provisional application No. 60/548,126, filed on Feb. 26, 2004.

(51) Int. Cl. G02B 26/08; G02B 27/10

(52) U.S. Cl. 359/619

(57) ABSTRACT

An optical unit for an illumination system of a microlithographic projection exposure apparatus has a refractive optical element which comprises an arrangement of a plurality of refractive subelements arranged next to one another in a plane. The optical unit also has a shadowing device by which at least one region on the refractive optical element can be deliberately shadowed at least partially. The shadowing makes it possible to control the angular distribution of light passing through the optical unit.

This application claims the benefit of Provisional Application No. 60/548,126 filed on Feb. 26, 2004.

### BACKGROUND OF THE INVENTION

1. Field of the Invention

The invention relates to an optical unit for an illumination system of a microlithographic projection exposure apparatus. More particularly, the invention relates to an optical unit comprising a refractive optical element with a plurality of refractive subelements arranged next to one another in a plane.

2. Description of Related Art

The term refractive optical element (ROE) generally refers to a flat optical element having a refractive effect in which, unlike conventional lenses or prisms, at least one refracting surface is structured. The refractive optical element can thus be regarded as being subdivided into a plurality of subelements, each of which being formed as conventional optical elements, for example lenses or prisms. The size of the subelements is typically between a few micrometres and about 1 mm. Examples of refractive optical elements are microlens arrays and Fresnel lenses.

Normally, refractive optical elements are used not as imaging optical elements but in order to selectively modify those properties of the transmitted light beam which cannot, or cannot easily, be controlled by conventional lenses. A typical field in which refractive optical elements are used involves illumination systems of microlithographic projection exposure apparatuses, as are used in the production of large-scale integrated electrical circuits.

Illumination systems of microlithographic projection exposure apparatuses are used to produce a projection light beam, which is directed at a reticle containing the structures to be projected. With the aid of a projection objective, these structures are imaged onto a photosensitive surface which, for example, may be applied to a wafer.

Known illumination systems may contain, for example, a laser used as the light source, a beam shaping device, a zoom-axicon objective for setting different types of illumination, and a rod homogenizer which is used to mix and homogenize the projection light produced by the laser. An adjustable masking device, which determines the geometry of the light field illuminating the reticle, is arranged behind the rod homogenizer. With the aid of a masking objective, the masking device is imaged onto the reticle to be illuminated, thus producing a light field with sharp edges on the reticle. Such illumination systems are known, for example, from U.S. Pat. No. 6,285,443.

Since the geometrical optical flux, i.e. the product of field size and the numerical aperture, cannot be increased with the optical elements as described above, one or more refractive optical elements are often positioned in a pupil plane of the illumination system for this purpose. In this context, for example, it is known to arrange two refractive optical elements mutually rotated by 90° in the vicinity of a pupil plane, each of which consisting of an arrangement of mutually parallel small cylindrical lenses. In this way, an angular distribution is imposed on the substantially collimated projection light beam impinging on the refractive optical element. The term angular distribution denotes the dependence of the light intensity on the ray direction. The general aim here is to distribute the available light intensity as uniformly as possible over the full available angle range, which may for example extend from −15° to +15°.

The projection light beam, which has been expanded by modifying its angular distribution, is then introduced into the rod homogenizer where it is mixed by multiple reflections. Intensity peaks in the angular distribution are at least partially balanced out during this mixing process, so that the projection light beam illuminates the masking device with the intended uniform angular distribution at a light exit face of the rod homogenizer.

Illumination systems without a rod homogenizer are also known. The projection light beam shaped by the refractive optical element is then delivered directly onto the masking device of the illumination system.

However, it is been found that the refractive optical elements used to date cannot produce a projection light beam which satisfies the requirements of angular distribution uniformity.

### SUMMARY OF THE INVENTION

It is therefore an object of the invention to provide an optical unit for an illumination system having a refractive optical element, wherein said refractive optical element makes it possible to achieve an intended angular distribution of the transmitted light, and in particular a constant angular distribution.

The invention furthermore relates to an illumination system—preferably not having a rod—for a microlithographic projection exposure apparatus, which has such a refractive optical element.

This object is achieved by an optical unit for an illumination system of a microlithographic projection exposure apparatus comprising a refractive optical element which includes a plurality of refractive subelements arranged next to one another in a plane. The unit further comprises a shadowing device that selectively shadows at least one region on the refractive optical element at least partially.

The invention is based on the discovery that the deviations of the angular distribution from the intended form are generally due to manufacturing technology. Deviations from the exactly intended form often occur particularly at the junctions between adjacent subelements of the refractive optical element since, at such places, the curvatures change very abruptly or curvatures of different signs merge into one another. The actual shape of the surface may then lead to the formation of fairly extensive quasiplanar regions on the surface of the refractive optical element. All light rays which pass through such a quasiplanar region will be refracted in the same direction and lead to an intensity peak in the angular distribution at the deviation angle in question. The angle at which the intensity peak occurs is dictated by the inclination of a quasiplanar regions relative to the optical axis of the refractive optical element.

Since these deviations from the intended form cannot be controlled by means of manufacturing technology, or can be controlled only with very great difficulty, the invention proposes that at least some of the regions where the actual angular distributions do not correspond to the intended angular distribution should be shadowed at least partially by means of a shadowing device. If the angular distribution is intended to be homogeneous, for example, so that it may be approximated by a rectangular function, then those regions on the refractive optical element which are responsible for the formation of intensity peaks in the angular distribution will be shadowed.

The optical unit according to the invention, however, can not only be used to convert substantially parallel light into light with an approximately homogeneous angular distribution. Rather, the optical unit also makes it possible to use additional shadowing in order to deliberately control the angular distribution provided by the refractive optical element. This control may furthermore be carried out retrospectively by appropriate alignment of the shadowing device, so that the unit can be used quite generally for retrospectively modifiable adjustment of a geometrical optical flux.

All means which can attenuate the intensity of light passing through them to a greater or lesser extent are suitable for the shadowing. Examples include the use of a greyscale plate, in which the individual regions have an increased capacity for absorption due to (partial) blackening. If a parallel light beam passes through such a greyscale plate, then a shadow image of the greyscale plate will be formed on the refractive optical element, so that the light refracted in particular directions can be attenuated even before the refraction if the geometry of the blackened regions is appropriate.

It is particularly preferable, however, for the shadowing device to comprise a plurality of at least partially opaque individual elements arranged at a distance from one another. Compared with a continuous greyscale plate, such an arrangement has the advantage that the individual elements can be oriented more easily relative to the refractive optical element. This possibility of orientation facilitates production of the shadowing device and also offers an opportunity for alignment, by which changes can be made to the shadowing effect even during operation.

The term shadowing should be understood very broadly in this context. Shadowing may be achieved both by semitransparent and by completely opaque individual elements, which may optionally also be placed directly on the refractive optical element. In the latter case, the refractive optical element is therefore covered locally, or even fully if the individual elements are completely opaque.

The arrangement of the individual elements in the shadowing device is dictated by the arrangement of the refractive subelements forming the refractive optical element. If the refractive optical element comprises two arrangements of parallel cylindrical lenses, for example, these arrangements being mutually rotated by approximately 90°, then the shadowing device may also comprise two arrangements of parallel individual elements, which are mutually rotated by approximately 90°. If there are irregular arrangements of the subelements, then the individual elements of the shadowing device may also be arranged irregularly. In this context, it should be noted that the intensity with which light emerges from the optical unit at a particular angle can also be reduced even without shadowing all the refractive subelements are where the light refracted by the angle in question passes through the refractive optical element.

With periodically arranged subelements, however, the most efficient attenuation for a particular angle range can be achieved when the individual elements of the shadowing device are also arranged periodically with the same period.

In an advantageous embodiment of the invention, the shadowing device comprises at least two sets of individual elements, which are arranged with the same period but mutually offset by any desired amount. In this way, the light passing through can be attenuated for angle ranges of different values.

The individual elements of the shadowing device, which are introduced into the light path in order to provide the shadowing, are preferably of elongated shape. A good shadowing effect is achieved in this way, especially when the subelements of the refractive optical element are cylindrical lenses. The elongated individual elements may, for example, be designed as wires and have a circular, oval or polygonal and, in particular, rectangular cross section.

Ovals and most polygonal cross sections make it possible to modify the width of the shadowed regions, and therefore the shadowing effect, by rotating the individual elements. To this end, the shadowing device may comprise an adjustment mechanism for rotating the individual elements about their longitudinal axis, so that alignment is possible even during operation.

The adjustment mechanism preferably comprises a plurality of individual drives, by which at least two individual elements may even be rotated independently of one another. The shadowing effect can thereby be adjusted individually for different angle ranges.

If at least one transverse dimension of the individual elements increases along their longitudinal axis, then the shadowing effect can be controlled by setting the longitudinal position of the individual elements. This setting may be carried out definitively during production of the shadowing device or subsequently, or even during operation if the shadowing device also has a displacement mechanism for moving the individual elements in their longitudinal direction.

If this displacement mechanism has a plurality of drive modules, by which the elongated individual elements can be moved independently of one another, then the shadowing effect can be retrospectively adjusted individually for different angle ranges.

Since it has been found that undesirable peaks in the angular distribution of the refractive optical elements occur particularly where there is a junction between two adjacent refractive subelements, it is preferable for at least one shadowed region on the refractive optical element to contain the junction between two adjacent refractive subelements.

For example, this transition region may be substantially flat, contain a protruding edge or even a slotted recess on the surface of the refractive optical element.

### BRIEF DESCRIPTION OF THE DRAWINGS

Various features and advantages of the present invention may be more readily understood with reference to the following detailed description taken in conjunction with the accompanying drawing in which:

FIG. 1 shows a meridian section through an illumination system of a microlithographic projection exposure apparatus, in a highly schematic representation which is not true to scale;

FIG. 2 shows a perspective representation of a first exemplary embodiment of an optical unit according to the invention;

FIG. 3 shows a section along the line III-III through the optical unit shown in FIG. 2;

FIG. 4 shows an angular distribution of light after passing through the optical unit shown in FIGS. 2 and 3;

FIG. 5 shows a section through a shadowing device according to another exemplary embodiment, in a highly schematic representation;

FIG. 6 shows another exemplary embodiment of an optical unit in a perspective representation;

FIG. 7 shows a section through the optical unit shown in FIG. 6 along the line VII-VII;

FIG. 8 shows a sectional representation, corresponding to FIG. 3, of an optical unit in which the refractive optical element is made of convex cylindrical lenses;

FIG. 9 shows a sectional representation, corresponding to FIG. 3, of an optical unit in which the refractive optical unit is made of concave cylindrical lenses;

FIG. 10 shows a schematic partial perspective representation to explain another exemplary embodiment of the invention;

FIG. 11 shows a section through a shadowing device for the exemplary embodiment shown in FIG. 10, in a highly schematic representation.

### DESCRIPTION OF PREFERRED EMBODIMENTS

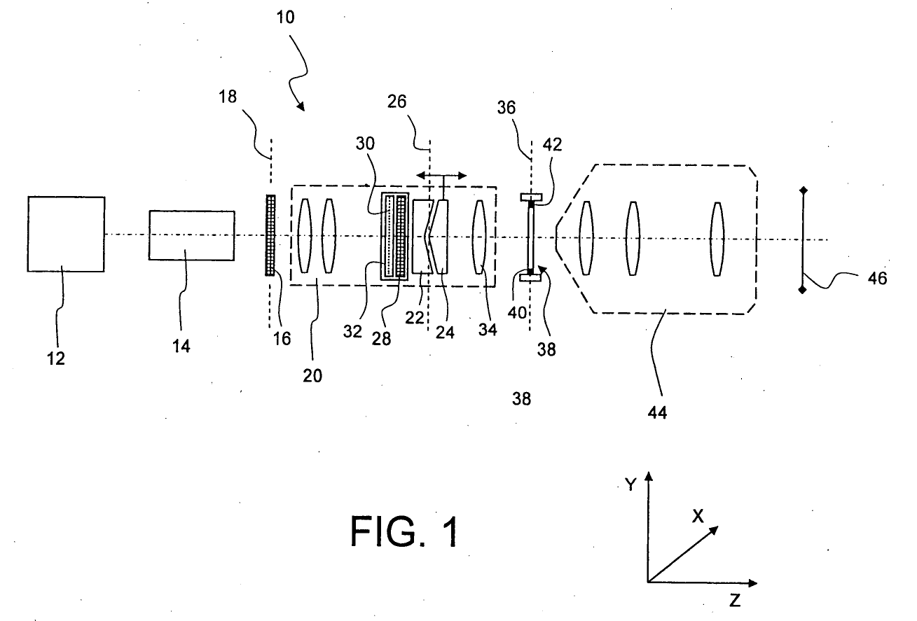

FIG. 1 represents an illumination system of a microlithographic projection exposure apparatus, denoted overall by 10, in a highly simplified meridian section which is not true to scale. The illumination system 10 has a light source 12 which, for example, may be embodied as an excimer laser and produces projection light with a wavelength in the ultraviolet radiation range, for example 193 nm or 157 nm. In a beam expander 14, which may for example be an adjustable mirror arrangement, the projection light produced by the light source 12 is expanded into a rectangular and substantially parallel beam of rays. The projection light, now expanded, subsequently passes through a first optical raster element 16, which may for example be a diffractive optical element with a two-dimensional raster structure, as described in U.S. Pat. No. 6,285,443.

The first optical raster element 16 is arranged in an object plane 18 of a zoom-axicon objective 20, which has two axicon elements 22, 24 arranged so that they can be displaced relative to each other, which are arranged in a pupil plane 26 of the zoom-axicon objective 20.

A second optical raster element, which is designed as a refractive optical element 28, is arranged immediately in front of the two axicon elements 22, 24, i.e. close to the pupil plane 26. Like the first raster element 16, the purpose of this refractive optical element 28 is to increase the geometrical optical flux, i.e. the product of field size and numerical aperture.

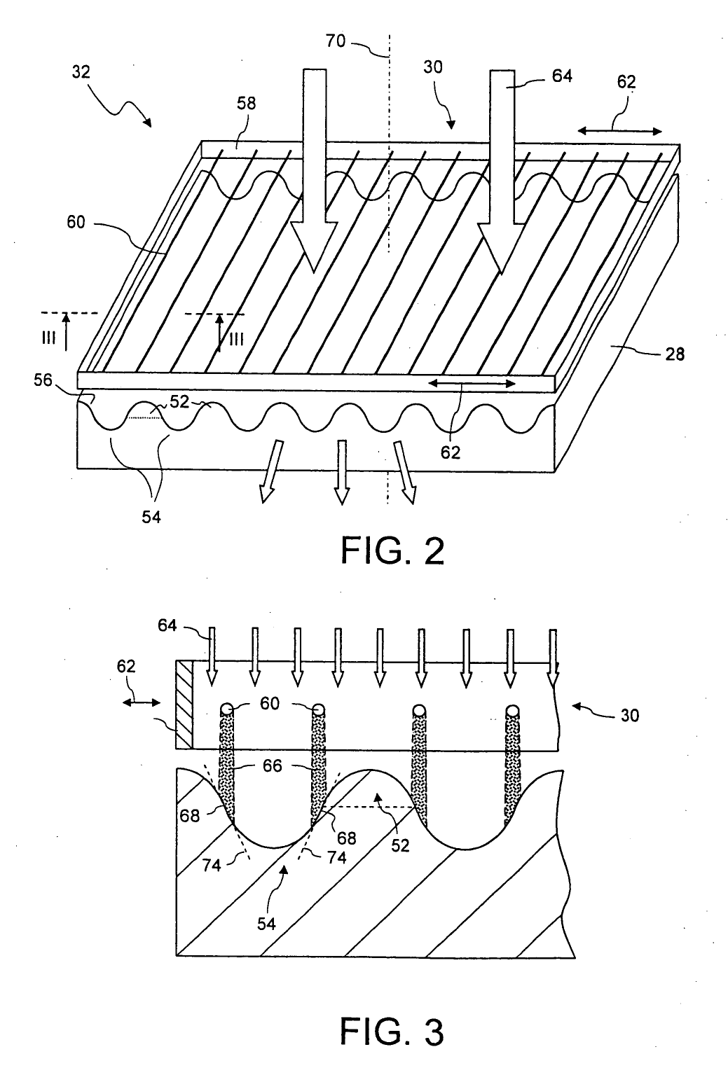

A shadowing device 30 is arranged immediately in front of the refractive optical element 28, and forms an optical unit 32 together with the refractive optical element 28. Details of this will be explained below with reference to FIGS. 2 to 11.

A masking device, denoted overall by 38, is arranged in an image plane 36 of the zoom-axicon objective 20, into which the first optical raster element 16 is imaged. The masking device 38 contains two pairs of mutually opposing blades, which can respectively be adjusted in the Y direction and in the X direction. Of these two pairs, the meridian section in FIG. 1 represents only the pair with the blades 40, 42 which can be moved the Y direction.

The blades of the masking device 38 which are arranged in the field plane 36 are imaged sharply onto a reticle 46 by a second objective 44, which is often also referred to as a REMA assembly (REMA=REticle MAsking). The reticle 46 is located in an object plane of a subsequent projection objective of the microlithographic projection exposure apparatus.

FIG. 2 shows a first exemplary embodiment of the optical unit 32 in a perspective representation. The refractive optical element 28 of the optical unit 32 comprises an arrangement of a plurality of refractive subelements arranged next to one another in a plane, although overall it has a monobloc design. In the exemplary embodiment represented in FIG. 2, the subelements are alternately arranged convex cylindrical lenses 52 and concave cylindrical lenses 54. This gives a corrugated shape to the surface 56 of the refractive optical element 50.

The shadowing device 30, which consists of a frame 58 with wires 60 tensioned inside it, is arranged above the refractive optical element 28. The wires 60 are arranged mutually parallel in a plane and, in the exemplary embodiment represented, spaced uniformly apart. The entire shadowing device 30 can be displaced relative to the refractive optical element 28 in a direction indicated by arrows 62.

FIG. 3 shows a section along the line III-III through the optical unit 32 shown in FIG. 2. It can be seen here that the wires 60 have a circular cross section. When light 64 which is at least approximately parallel to an optical axis 70 of the optical unit 32 strikes the optical unit 32 from above, then the wires 60 cast shadows 66 onto the underlying surface 56 of the refractive optical element 28.

The distances between the wires 60, and the relative position between the shadowing device 30 and the refractive optical element 28, are in this case selected so that the shadows 66 are cast onto regions 68 of the surface 56 of the refractive optical element 28 where the concave cylindrical lenses 54 merge into the convex cylindrical lenses, and vice versa. Since the curvature of the surface 56 changes its sign in the vicinity of these junctions, the regions 68 are referred to below as inflection point regions. It is to be understood that the regions 68 are not point-like regions but long narrow strips, which extend in the longitudinal direction of the cylindrical lenses 52, 54.

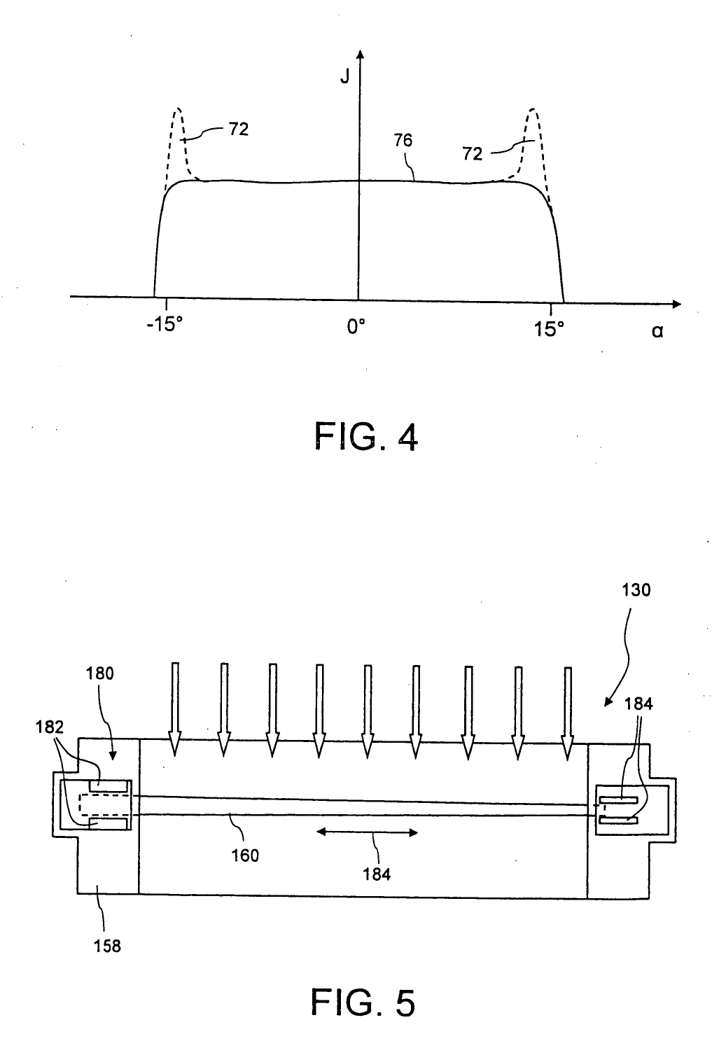

A solid line in FIG. 4 shows an angular distribution for the light 64 after passing through the optical unit 32. In the graphs, the intensity J is plotted against the angle α which is measured relative to the optical axis 70 of the optical unit 32. For comparison, the angular distribution is also indicated by a broken line for the case in which the shadowing device 30 is omitted.

It can be seen in the graphs that, without a shadowing device 30, intensity peaks 72 occur at the outer angle ranges whereas the angular distribution otherwise has the intended approximately constant profile. The intensity peaks 72 are due to the fact that the surface 56 of the refractive optical element 28 does not exactly have the per se intended shape close to the inflection point regions 68. Referring to the section plane shown in FIG. 3, the junction between the convex cylindrical lenses 52 and the concave cylindrical lenses 54 is not formed merely by a point where the curvature of the surface 56 is identically zero. Rather, the curvatures close to this theoretical inflection point are so small that there are extended flat surfaces around the theoretical inflection points, the orientations of which are indicated by broken lines 74 in FIG. 3. All light rays 64 which strike these quasiplanar surfaces of the inflection point regions 68 are refracted in one direction and lead to formation of the intensity peaks 72 in the angular distribution.

Owing to the shadowing of the inflection point regions 68 by the wires 60, the amount of light 64 passing through the inflection point regions 68 is so small that the angular distribution assumes the approximately rectangular functional dependency as indicated by a solid line in FIG. 4.

In order to completely eliminate the intensity peaks 72 in the vicinity of the peripheral angles, but without experiencing an undesirable reduction of the intensity to below the average intensity level 76 close to the peripheral angles, the shadowing effect due to the wires 60 should be adapted to each individual refractive optical element 28. This is because the formation of the quasiplanar flat surfaces at the inflection point regions 68 is due to manufacturing tolerances, so that the height of the intensity peaks 72 may turn out differently for each refractive optical element 28.

With strictly periodic surfaces 56, as is the case in the exemplary embodiment of a refractive optical element 28 as represented in FIGS. 2 and 3, on the one hand it is necessary to ensure that the distance between the wires 60 also corresponds exactly to the periodicity of the subelements, that is to say the cylindrical lenses 52, 54. If there is a small periodicity mismatch, then only a few inflection point regions 68 will be shadowed by wires 60 and the intensity peaks 72 in the angular distribution will therefore be reduced only slightly.

If the aforementioned periodicity condition is satisfied, then the shadowing effect and therefore the reduction of the intensity peaks 72 can be modified in a straightforward way by moving the shadowing device 30 in the direction of the arrow 62 relative to the refractive optical element 28. In this way, however, it is merely possible to shift the angulation of the shadowing effect. In the extreme case, this may mean that although the intensity peaks 72 are completely eliminated, undesirable dips in the angular distribution are nevertheless also created in the neighbouring angle range.

It is therefore most favourable for the cross section of the wires 60 to be modified in order to adjust the shadowing effect, since the width of the shadows 66 and therefore the entire shadowing effect can be controlled in this way.

FIG. 5 shows a simplified sectional representation of a shadowing device 130 in which, although the wires 160 are circular in cross section as before, their diameter furthermore decreases in the longitudinal direction. The wires 160, which are therefore conically shaped overall, are held in a displacement mechanism indicated only schematically and denoted overall by 180, which is itself arranged in a frame 158 of the shadowing device 130. The displacement mechanism has a drive module 182, by which the conical wires 160 can be moved together in their longitudinal direction as indicated by an arrow 184. The drive module 182 may in this case be operated by hand or using a motor. On the other side from the drive module 182, the displacement mechanism 180 has schematically indicated recesses 184 for guiding the wires 160.

If the wires 160 are moved to the right from the position shown in FIG. 5 with the aid of the displacement device 180, then the shadowing effect of the wires 160 increases because the cross section is now larger overall. Less light is therefore refracted into the angle range which is defined by the placement of the wires 180 relative to the refractive optical element 28.

In the exemplary embodiment of a shadowing device 130 as shown in FIG. 5, it is assumed that the displacement mechanism 180 acts simultaneously on all the wires 160 of the shadowing device 130. In the event that more regions on the surface 56 of the refractive optical element 28 are intended to be shadowed in addition to the regions 68, it is expedient to provide further wires which can preferably be adjusted independently of the other wires in the longitudinal direction 184.

This makes it necessary either to provide drive modules 182 which can be operated individually for each wire 160, or to couple the wires 160 together so that groups of wires can be adjusted together by a drive module.

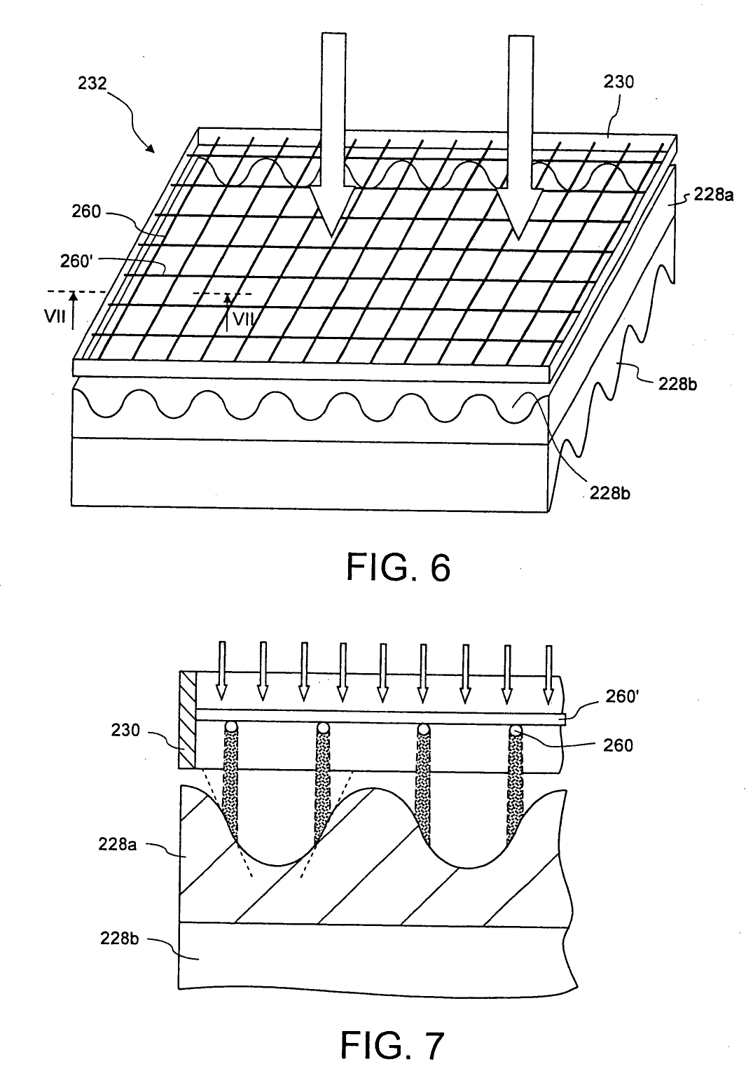

FIGS. 6 and 7 respectively show a perspective representation and a section along the line VII-VII of another exemplary embodiment of an optical unit, which is denoted overall by 232. The optical unit 232 comprises a first refractive optical element 228a, which is designed in the same way as the refractive optical element 28 shown in FIG. 2. Fastened to the lower side 268 of the refractive optical element 228a, there is a second refractive optical element 228b which is also designed like the refractive optical element 28 shown in FIG. 2, but whose orientation is rotated by 90° relative to the first refractive optical element 228a. Together, the refractive optical elements 228a, 228b thereby form an arrangement of crossed cylindrical lenses, so that beam expansion is obtained in two mutually perpendicular directions.

In order to achieve at least partial shadowing of the inflection point regions 68 for the lower refractive optical element 228b as well, a shadowing device 230 of the optical unit 232 has a grid arrangement of crossed wires 260, 260′ which may be placed directly on one another, as shown by FIG. 7. If different angular distributions are intended in the two mutually perpendicular directions, then differing curvatures of the cylindrical lenses should accordingly be selected. The periodicity of the wires 260 in one direction then differs from the periodicity of the wires 260′ in the direction perpendicular to this.

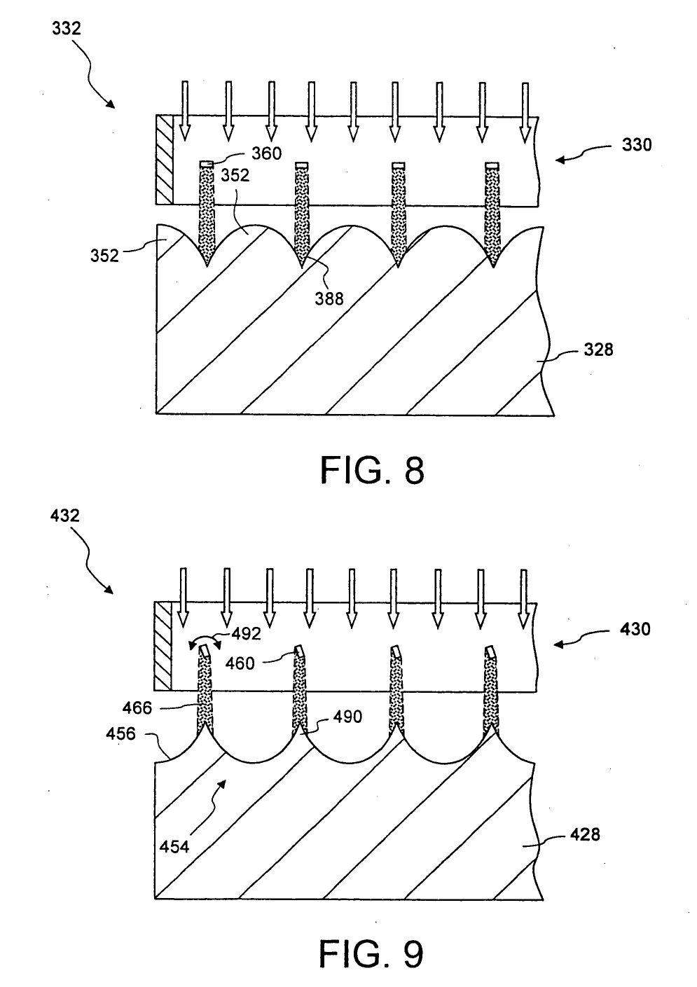

FIGS. 8 and 9 show other embodiments of optical units 332 and 432 in sectional representations, similarly as in FIGS. 2 and 7.

In the exemplary embodiment shown in FIG. 8, the refractive optical element 328 is formed exclusively by convex cylindrical lenses 352 which form cuneiform slotted recesses 388 wherever they touch one another. These cuneiform slotted recesses 388 can likewise lead to the formation of undesirable intensity peaks in the angular distribution. A shadowing device 330 of the optical unit 332 is therefore oriented relative to the refractive optical element 328 so that the slotted recesses 388 are shadowed.

In contrast to the exemplary embodiments explained above, the individual elements which cause shadowing in the optical unit 332 are designed not as wires but as narrow strips 360 with a rectangular cross section.

In the exemplary embodiment shown in FIG. 9, the subelements of the refractive optical element 428 are designed as concave cylindrical lenses 454 arranged mutually parallel. Wherever the cylindrical lenses 454 touch one another, outwardly raised edges 490 are created on the surface 456 of the refractive optical element 428, and intensity peaks in the angular distribution may likewise occur at them. These edges 490 are therefore shadowed by the shadowing device 430.

A particular feature of the shadowing unit 430 is that it has strips 460 which can be rotated about their longitudinal axis, as indicated by an arrow 492. The width of the shadows 466 which the strips 460 cast onto the surface 456 of the refractive optical element 428 can be controlled by rotating the strips 460.

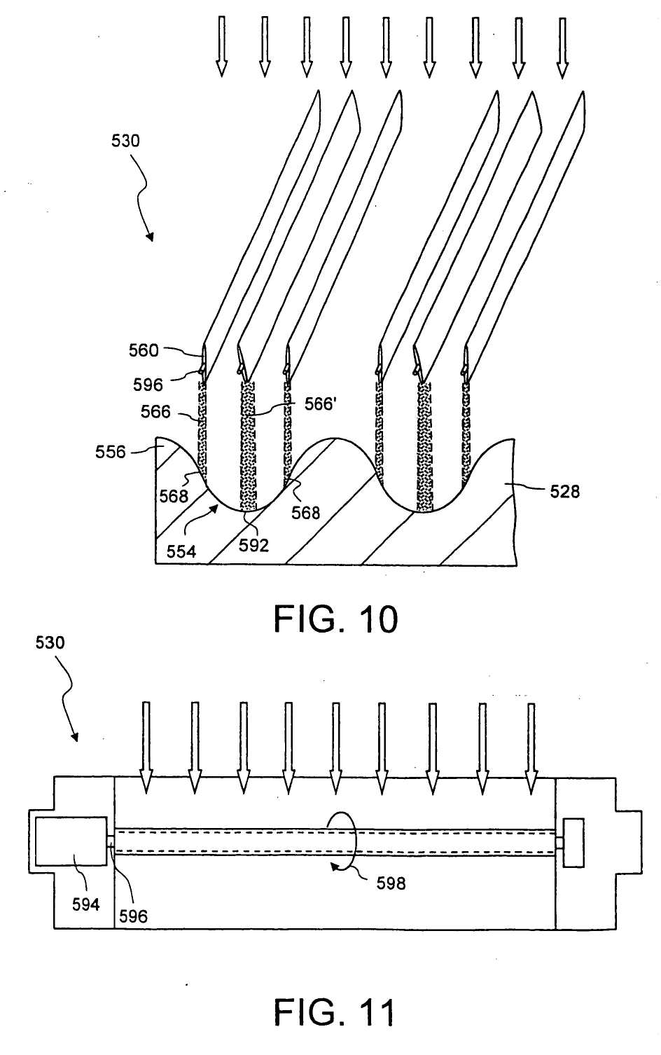

FIG. 10 shows a partial perspective representation of another variant of an optical unit, in which only a few individual elements of a shadowing device are represented for the sake of clarity. The refractive optical element in this exemplary embodiment is designed just like the refractive optical element 28 shown in FIGS. 2 and 3. The individual elements of the shadowing device 530 are designed in the form of strips, but have an elliptical instead of rectangular cross section. Similarly to the exemplary embodiment shown in FIG. 9, the strips 560 can be rotated about their longitudinal axis so that the shadowing effect can be varied.

Unlike the exemplary embodiment represented in FIG. 9, however, the strips 560 can be adjusted individually. This makes it possible to cast shadows 566, 566′ of different width onto the surface 556 of the refractive optical element 528. For example, this may be expedient when not only inflection point regions 568 on the surface 556 but also other regions 592 are intended to be shadowed. In the exemplary embodiment represented, these other regions 592 are the deepest regions of the concave cylindrical lenses 554. Quasiplanar surfaces, which can lead to the formation of undesirable intensity peaks in the angular distribution, may sometimes also be encountered there owing to production.

FIG. 11 shows a schematic section perpendicular to the plane of the paper through the shadowing device 530, as may also be employed in the exemplary embodiment shown in FIG. 9. Positioning motors 594 act via shafts 596 on the strips 560, and therefore make it possible to rotate them about their longitudinal axis as indicated by an arrow 598. Such adjustable shadowing devices are known per se from EP 1 291 721 A1, although they are used there for uniform illumination of the light field in a reticle plane.

1. An optical unit for an illumination system of a microlithographic projection exposure apparatus, said unit comprising:
refractive optical element which includes a plurality of refractive subelements arranged next to one another in a plane,
shadowing device that selectively shadows at least one region on the refractive optical element at least partially.

2. The optical unit of claim 1, wherein the shadowing device comprises a plurality of at least partially opaque individual elements arranged at a distance from one another.

3. The optical unit of claim 2, wherein the at least one individual element is placed directly on the refractive optical element.

4. The optical unit of claim 2, wherein both the subelements of the refractive optical element and the individual elements of the shadowing device are arranged periodically.

5. The optical unit of claim 4, wherein the subelements of the refractive optical element and the individual elements of the shadowing device are arranged with the same period.

6. The optical unit of claim 5, wherein the shadowing device comprises at least two sets of individual elements that are arranged with the same period but mutually offset.

7. The optical unit of claim 2, wherein at least one individual element has an elongated shape with a longitudinal axis.

8. The optical unit of claim 7, wherein the at least one individual element has an oval or polygonal cross section.

9. The optical unit according to claim 8, wherein the shadowing device has an adjustment mechanism for rotating the at least one individual element about its longitudinal axis.

10. The optical unit of to claim 9, wherein the adjustment mechanism comprises a plurality of individual drives for independently rotating at least two individual elements.

11. The optical unit of claim 7, wherein the at least one individual element has a transverse dimension that increases along its longitudinal axis.

12. The optical unit of claim 11, wherein the shadowing device has a displacement mechanism for moving the at least one individual element in its longitudinal direction.

13. The optical unit of to claim 12, wherein the displacement mechanism comprises a plurality of drive modules for independently moving the individual elements.

14. The optical unit of claim 1, wherein at least one shadowed region on the refractive optical element contains a junction between two adjacent refractive subelements.

15. The optical unit of claim 14, wherein the at least one shadowed region on the refractive optical element is at least substantially flat.

16. The optical unit claim 15, wherein the at least one shadowed region contains a protruding edge on a surface of the refractive optical element.

17. The optical unit of 15, wherein the at least one shadowed region contains a slotted recess on a surface of the refractive optical element.

18. The optical unit of claim 1, wherein the refractive optical element comprises at least two arrangements of parallel cylindrical lenses, these arrangements being mutually rotated by approximately 90°.

19. The optical unit of claim 2, wherein the refractive optical element comprises at least two arrangements of parallel cylindrical lenses, these arrangements being mutually rotated by approximately 90°, and wherein the shadowing device comprises two arrangements of parallel individual elements, these arrangements being mutually rotated by approximately 90°.

20. An illumination system of a microlithographic projection exposure apparatus, comprising a light source and an optical unit according to claim 1.

21. The illumination system of claim 20, wherein the optical unit is arranged in or close proximity to a pupil plane.

22. The illumination system of claim 21, comprising a zoom-axicon objective in which the pupil plane is located.
